(19) United States
(12) Patent Application Publication
(10) Pub. No.: US 2013/0091847 A1
(43) Pub. Date: Apr. 18, 2013

(54) COMBUSTOR LINER

(71) Applicant: Wei CHEN, Greer, SC (US)

(72) Inventor: Wei CHEN, Greer, SC (US)

(73) Assignee: General Electric Company, Schenectady, NY (US)

(21) Appl. No.: 13/272,838

(22) Filed: Oct. 13, 2011

(51) Int. Cl. F02C 3/14

(52) U.S. Cl. 60/752

(57) ABSTRACT

A combustor liner is provided. The combustor liner has a first end, including a forward end liner formed to define a converging interior through which a main flow is directed to flow and a second end. The second end is fluidly coupled to an aft portion of the first end and includes an aft end liner formed to define a diverging interior receptive of the main flow and through which the main flow is directed to continue to flow.

### BACKGROUND OF THE INVENTION

The subject matter disclosed herein relates to turbomachine components and, more particularly, to a combustor liner.

In modern turbomachines, such as gas turbine engines, compressed gas and fuel are mixed and combusted within a combustor to produce high temperature fluids. These high temperature fluids are then transported to a turbine section for power generation operations by way of a transition piece. The transition piece is formed of a liner that extends from the combustor and couples, at an aft end thereof, to a forward end of the turbine.

The aft end of the liner is often a weak spot in the overall liner construction and experiences hot side thermal loading that can lead to damage and decreased life. Typically, the hot side thermal loading is addressed by a cooling structure coupled to the liner. However, this cooling structure may be complex, may cause the main flow of the high temperature fluids to separate and may have non-uniform distribution of fluids in its channels.

### BRIEF DESCRIPTION OF THE INVENTION

According to one aspect of the invention, a combustor liner is provided. The combustor liner has a first end, including a forward end liner formed to define a converging interior through which a main flow is directed to flow and a second end. The second end is fluidly coupled to an aft portion of the first end and includes an aft end liner formed to define a diverging interior receptive of the main flow and through which the main flow is directed to continue to flow.

According to another aspect of the invention, a turbomachine is provided. The turbomachine has a first vessel formed to define a first vessel interior through which a main flow is directed, the first vessel including an aft end liner formed to define a venturi feature and a second vessel fluidly coupled to and disposed downstream from the first vessel. The second vessel is formed to define a second vessel interior receptive of the main flow and through which the main flow is directed to continue to flow.

According to yet another aspect of the invention, a turbomachine is provided and includes a first vessel formed to define a first vessel interior through which a main flow is directed and a second vessel fluidly coupled to and disposed downstream from the first vessel, the second vessel being formed to define a second vessel interior receptive of the main flow and through which the main flow is directed to continue to flow. The first vessel has a first end, including a forward end liner formed to define a converging interior through which the main flow is directed to flow and a second end. The second end is fluidly coupled to an aft portion of the first end and includes an aft end liner formed to define a diverging interior receptive of the main flow and through which the main flow is directed to continue to flow.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of a venturi combustor liner in accordance with embodiments; and

FIG. 2 is a side of a venturi combustor liner in accordance with further embodiments.

The detailed description explains embodiments of the invention, together with advantages and features, by way of example with reference to the drawings.

### DETAILED DESCRIPTION OF THE INVENTION

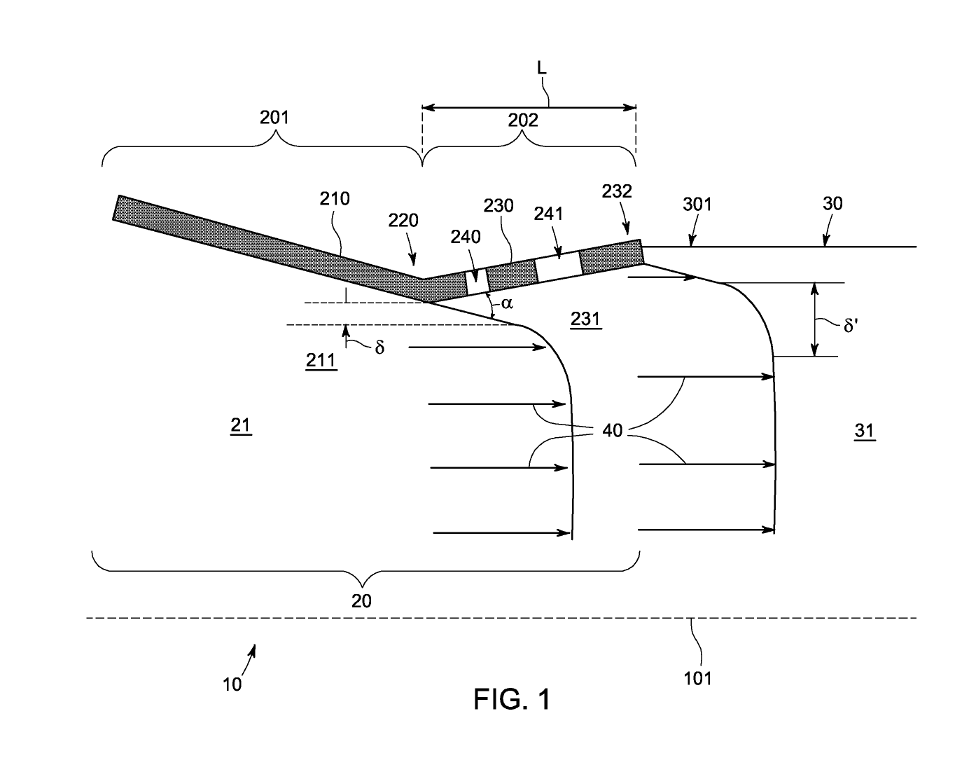

With reference to FIG. 1, a portion of a turbomachine 10 is provided as a venturi combustor liner and includes a first vessel 20 and a second vessel 30. The first vessel 20 is formed to define a first vessel interior 21 through which a main flow 40 may be directed to flow. The second vessel 30 is fluidly coupled to and disposed downstream from the first vessel 20 relative to the direction of the flow of the main flow 40. The second vessel 30 is formed to define a second vessel interior 31, which is receptive of the main flow 40 and through which the main flow 40 may be directed to continue to flow in a downstream direction.

The first vessel 20 includes a first end 201 and a second end 202. The first end includes a forward end liner 210, which is formed to define a converging interior 211 through which the main flow 40 is directed to flow. The second end 202 is fluidly coupled to an aft portion 220 of the first end 201 and includes an aft end liner 230. The aft end liner 230 is formed to define a diverging interior 231, which is receptive of the main flow 40 and through which the main flow is directed to continue to flow. An upstream end 301 of the second vessel 30 may be coupled to a downstream end 232 of the aft end liner 230.

Thus, as shown in the sole figure, the first vessel 20 is formed to define a venturi feature at or around the aft portion 220 thereof. The diverging interior 231 diverges from the venturi feature and thus provides for reduced flow velocities of the main flow 40 near the aft end liner 230 in the radial dimension. These velocity reductions can be up to about 20% to about 40% of the flow velocities of the main flow 40 remote from the aft end liner 230 in the radial dimension and can lead to reductions in hot side thermal loading, costs and emissions of oxides of nitrogen (NOx) as well as extensions of liner life and increases in combustion efficiencies.

That is, at or around the axial location of the venturi feature, a flow of hot gases proceeding from the first vessel interior 21 to the second vessel interior 31 may have a boundary layer of thickness δ. Beyond the venturi feature, the boundary layer begins to grow at an expansion angle α such that the flow passing the downstream end 232 of the aft end liner 230 has a boundary layer of δ′. As thermal loading may be inversely proportional to the boundary layer grow rate (i.e., r=δ′/δ), the venturi feature described herein can reduce thermal loading by, in some cases, more than 90% with aft end liner 230 durability significantly increased.

In accordance with embodiments, the first vessel 20 may include a transition piece liner or an aft portion thereof. Similarly, the second vessel 30 may include a turbine section or a forward portion thereof.

In accordance with further embodiments, an angling of the aft end liner 230 relative to a centerline 101 of the turbomachine 10 is between about 2.5 to about 15 degrees. Also, the aft end liner 230 has a length L of about 4 inches along the centerline 101. Still further, at least one of the forward end liner 210 and the aft end liner 230 may be formed to define one or more cooling holes 240 and/or one or more cooling slots 241.

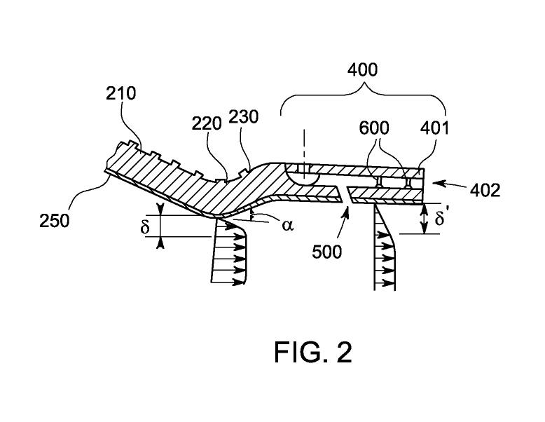

In accordance with further embodiments, with reference to FIG. 2, at least the forward end liner 210 and the aft end liner 230 may include a thermal barrier coating (TBC) 250. Also, the aft end liner 230 may be formed as a long aft section having a horizontal section 400 extending in the aft direction from the aft end liner 230. In this case, the thermal loading can be attenuated by the venturi feature expansion angle α and the horizontal section 400 may serve to sustain the attenuated effect of the thermal loading.

The horizontal section 400 may include a body 401, which is formed to define a pathway 402 through which compressor discharge air (CDC air), for example, may flow in the aft direction. The body 401 may be further formed to define surge holes 500 through which the CDC air can flow from the pathway 402 and towards the main flow 40 and the second vessel interior 31. The surge holes 500 may thus prevent or at least reduce hot gas re-attachment to a surface of the aft end liner 230 and may thereby increase stability of the boundary layer. The surge holes 500 may be positioned on or near hot streaks where hot gases have relatively high temperatures and velocities. The horizontal section 400 may also include internal or cold side ribs 600. The ribs 600 may be disposed within the pathway 402 and serve to increase surface area of the aft end liner 230 and cooling thereof.

As mentioned above, the reduction of thermal load is related to the growth rate of the boundary layer near the aft end liner 230 (r=δ′/δ) and the venturi feature expansion angle α. In accordance with embodiments, a venturi feature expansion angle α of greater than 5 degrees may be employed but an excessively large venturi feature expansion angle α (i.e., α is greater than 25 degrees) may result in flow separation and instability. At such excessively large venturi feature expansion angles α, surge holes 500 may be necessary.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor liner, comprising:
a first end, including a forward end liner formed to define a converging interior through which a main flow is directed to flow; and
a second end, fluidly coupled to an aft portion of the first end, the second end including an aft end liner formed to define a diverging interior receptive of the main flow and through which the main flow is directed to continue to flow.

2. The combustor liner according to claim 1, wherein an angling of the aft end liner relative to a centerline of the turbomachine liner is between about 2.5 to about 15 degrees.

3. The combustor liner according to claim 2, wherein the aft end liner has a length of about 4 inches along the centerline of the turbomachine liner.

4. The combustor liner according to claim 1, wherein at least one of the forward and the aft end liner is formed to define one or more cooling holes.

5. The combustor liner according to claim 1, wherein at least one of the forward and the aft end liner is formed to define one or more cooling slots.

6. The combustor liner according to claim 1, wherein the aft end liner includes an aft extending horizontal section.

7. The combustor liner according to claim 6, wherein the horizontal section is formed to define a pathway and a surge hole for air flow from the pathway and toward the main flow.

8. The combustor liner according to claim 7, wherein the horizontal section comprises ribs disposed in the pathway.

9. A turbomachine, comprising:
a first vessel formed to define a first vessel interior through which a main flow is directed, the first vessel including an aft end liner formed to define a venturi feature; and
a second vessel fluidly coupled to and disposed downstream from the first vessel, the second vessel being formed to define a second vessel interior receptive of the main flow and through which the main flow is directed to continue to flow.

10. The turbomachine according to claim 9, wherein an angling of the aft end liner relative to a centerline of the turbomachine is between about 2.5 to about 15 degrees.

11. The turbomachine according to claim 9, wherein the aft end liner has a length of about 4 inches along a centerline of the turbomachine.

12. The turbomachine according to claim 9, wherein at least the aft end liner is formed to define one or more cooling holes.

13. The turbomachine according to claim 9, wherein at least the aft end liner is formed to define one or more cooling slots.

14. A turbomachine, comprising:
a first vessel formed to define a first vessel interior through which a main flow is directed; and
a second vessel fluidly coupled to and disposed downstream from the first vessel, the second vessel being formed to define a second vessel interior receptive of the main flow and through which the main flow is directed to continue to flow,
the first vessel comprising:
a first end, including a forward end liner formed to define a converging interior through which the main flow is directed to flow; and
a second end, fluidly coupled to an aft portion of the first end, the second end including an aft end liner formed to define a diverging interior receptive of the main flow and through which the main flow is directed to continue to flow.

15. The turbomachine according to claim 14, wherein the first vessel comprises a transition piece liner and the second vessel comprises a turbine section.

16. The turbomachine according to claim 14, wherein an upstream end of the second vessel is fluidly coupled to a downstream end of the aft end liner.

17. The turbomachine according to claim 14, wherein an angling of the aft end liner relative to a centerline of the turbomachine is between about 5 to about 15 degrees.

18. The turbomachine according to claim 17, wherein the aft end liner has a length of about 4 inches along the centerline of the turbomachine.

19. The turbomachine according to claim 14, wherein at least one of the forward and the aft end liner is formed to define one or more cooling holes.

20. The turbomachine according to claim 14, wherein at least one of the forward and the aft end liner is formed to define one or more cooling slots.
